(19) United States
(12) Patent Application Publication
(10) Pub. No.: US 2025/0342472 A1
(43) Pub. Date: Nov. 6, 2025

(54) INFORMATION SECURITY TECHNIQUES FOR PREVENTING BRUTE FORCE ATTACKS ON NETWORKED COMPUTER SYSTEMS

(71) Applicant: MASTERCARD TECHNOLOGIES CANADA ULC, Vancouver (CA)

(72) Inventors: Kyle Williams, Wentzville, MO (US); Jonathan McGrandle, Maple Ridge (CA); Matthew Melnik, Delta (CA)

(21) Appl. No.: 19/194,890

(22) Filed: Apr. 30, 2025

Related U.S. Application Data
(60) Provisional application No. 63/640,969, filed on May 1, 2024.

(51) Int. Cl. G06Q 20/40

(52) U.S. Cl. CPC G06Q 20/4014; G06Q 20/4016; G06Q 20/407

(57) ABSTRACT

A system includes an originating client platform, a first intermediate client platform, and a bridge platform. A first electronic processor of the originating client platform is configured to generate an authorization request and transmit the authorization request. A second electronic processor of the first intermediate client platform is configured to receive the authorization request and determine whether the authorization request is malicious or not malicious. In response to determining that the authorization request is malicious, the second electronic processor is configured to store the authorization request in a data store, transmit an authorization request denial, and transmit an incident payload including details of the authorization request. A third electronic processor of the bridge platform is configured to receive the incident payload, generate a security profile based on the incident payload, and transmit the security profile to a second intermediate client platform.

### CROSS-REFERENCE TO RELATED APPLICATIONS

This application claims the benefit of U.S. Provisional Application No. 63/640,969 filed May 1, 2024, the entire disclosure of which is incorporated by reference.

### FIELD

The present disclosure relates to information security techniques and, more particularly, to information security techniques for detecting and preventing brute-force attacks on networked computer systems.

### SUMMARY

Brute-force attacks can create a series of technical problems and challenges for networked computer systems. Generally, brute-force attacks involve generating a high-volume of malicious access attempts in a defined time period to gain access to a protected computer resource. For example, brute-force attacks may iterate through possible combinations of credentials and transmit the combinations over networked computer systems to gain access to protected resources. Because these attacks often generate a high volume of malicious network traffic, they may consume a significant amount of computer resources (such as processor resources, memory resources, and/or network bandwidth). This high volume of malicious network traffic can also degrade the performance of networked computer systems. In scenarios where the high volume of malicious network traffic generated by the brute-force attack overwhelms available system resources, the attack can lead to a denial-of-service (DOS) for legitimate users of the networked computer systems (where the legitimate users may be unable to access the networked computer systems).

Credit card payment networks may use networked computer platforms to facilitate the electronic transactions and communications necessary when users use a credit card to make a purchase. For instance, the networks may include one or more bridge platforms that function as a conduit between originating client platforms (such as merchant platforms), intermediate client platforms (such as issuing bank platforms), and destination client platforms (such as acquiring bank platforms). The bridge platforms may implement the credit card payment network by ensuring that transactions are authenticated, authorized, and settled correctly. Card testing is a form of brute-force attack that may be carried out over the networked computer platforms. Generally, in card testing attacks, cybercriminals may use automated tools to transmit high volumes of malicious authorization attempts over the networked computer platforms. For example, cybercriminals may iteratively cycle through combinations of primary account numbers, expiration dates, and/or card verification values and transmit each combination over the networked computer platforms in an attempt to find valid combinations. In examples with 16-digit primary account numbers where the first six digits function as a fixed bank identification number (which may identify the issuing bank) and the last digit functions as a check digit, there are nine remaining digits that cybercriminals can iterate through to find valid combinations (or 109=1,000,000,000 possible combinations for each fixed bank identification number). Assuming that credit cards are typically valid for five years into the future and that there are 12 months in a year, there are a total of 12× 5=60 possible combinations of expiration dates that cybercriminals can iterate through. Finally, assuming that the card verification value is a three-digit numerical value, there are a total of 10³=1,000 possible combinations of card verification values that cybercriminals can iterate through.

Thus, in the previous example, cybercriminals can iterate through 1,000,000,000×60×1,000=60,000,000,000,000 combinations of primary account numbers, expiration dates, and card verification values to find a valid combination. Given the large quantity of possible combinations, cybercriminals often need to generate a high volume of malicious authorization attempts to find a single valid combination of primary account number, expiration date, and card verification value. Because card testing attacks involve generating and transmitting high volumes of malicious authorization attempts over networked computer systems, card testing attacks may consume correspondingly large volumes of available computing resources, potentially degrading the performance of the networked computer system for legitimate users.

Typically, card testing attacks may originate at the originating client platform. Each card testing attack may be transmitted from the originating client platform to the intermediate client platform. The attack may then be transmitted from the intermediate client platform to the bridge platform, and from the bridge platform to the destination client platform. Techniques described in this specification provide technical benefits that may harden networked communication systems against the effects of such brute force attacks by identifying and intercepting the malicious network traffic before it reaches the bridge platform (and is transmitted onwards from the bridge platform). Since the bridge platform may be a central node in the networked computer system (for example, interconnecting a greater number of client platforms), protecting preventing the high volumes of malicious network traffic from reaching the bridge platform eliminates or greatly reduces the likelihood that the client platforms will encounter degraded network performance or a denial of service.

Furthermore, techniques described in this specification provide additional technical benefits related to network performance and network security by monitoring security-related events (such as brute-force attacks) in the system in real time or near-real time and dynamically adapting client platforms to harden the overall system against the attacks. For example, malicious network traffic may be identified and/or intercepted at a specific intermediate client platform. The intermediate client platform may transmit details about and/or the attack itself to the bridge platform. The bridge platform may generate a security profile based on the attack and push the security profile out to other client platforms in the system. By updating client platforms with security profiles that include the latest threat intelligence information in real time or near-real time, techniques described in this specification ensure that, after a client platform encounters an attack, the system quickly adapts and hardens the remaining client platforms from similar attacks, reducing or eliminating the likelihood of similar attacks penetrating the system at other client platforms.

A system includes an originating client platform including a first electronic processor and a first communications interface, a first intermediate client platform including a second electronic processor, a second communications interface, and a data store, and a bridge platform including a third electronic processor and a third communications interface. The first electronic processor is configured to generate an authorization request and transmit the authorization request via the first communications interface. The second electronic processor is configured to receive the authorization request via the second communications interface and determine whether the authorization request is malicious or not malicious. In response to determining that the authorization request is malicious, the second electronic processor is configured to store the authorization request in the data store, transmit an authorization request denial via the second communications interface, and transmit an incident payload including details of the authorization request via the second communications interface. The third electronic processor is configured to receive the incident payload via the third communications interface, generate a security profile based on the incident payload, and transmit the security profile to a second intermediate client platform via the third communications interface.

In other features, the authorization request includes a merchant identifier and a bank identification number. The second electronic processor is configured to parse stored authorization requests in the data store to determine a number of stored authorization requests that include the merchant identifier and the bank identification number submitted over a time period and determine that the authorization request is malicious in response to the number being greater than or equal to a threshold. In other features, the authorization request includes a merchant identifier. The second electronic processor is configured to parse stored authorization requests in the data store to determine a number of unique bank identification numbers present in stored authorization requests associated with the merchant identifier submitted over a time period and determine that the authorization request is malicious in response to the number being greater than or equal to a threshold.

In other features, the authorization request comprises a merchant identifier. The second electronic processor is configured to parse stored authorization requests in the data store to determine a number of unique primary account numbers present in the stored authorization requests associated with the merchant identifier submitted over a time period and determine that the authorization request is malicious in response to the number being greater than or equal to a threshold. In other features, the authorization request comprises a merchant identifier and a primary account number. The second electronic processor is configured to parse stored authorization requests in the data store to determine a number of stored authorization requests associated with the merchant identifier and the primary account number and determine that the authorization request is malicious in response to the number being greater than or equal to a threshold.

In other features, the authorization request comprises a merchant identifier and a transaction amount. The second electronic processor is configured to parse stored authorization requests in the data store to determine a number of stored authorization requests associated with the merchant identifier and the transaction amount and determine that the authorization request is malicious in response to the number being greater than or equal to a threshold. In other features, the authorization request comprises a primary account number and a transaction amount. The second electronic processor is configured to parse stored authorization requests in the data store to determine a number of stored authorization requests associated with the primary account number and the transaction amount submitted over a time period and determine that the authorization request is malicious in response to the number being greater than or equal to a threshold.

In other features, the authorization request comprises a merchant identifier. The second electronic processor is configured to parse stored authorization requests in the data store to determine a number of declined authorization requests associated with the merchant identifier submitted over a time period and determine that the authorization request is malicious in response to the number being greater than or equal to a threshold. In other features, the authorization request comprises user account data and a bank identification number. The second electronic processor is configured to parse stored authorization requests in the data store to determine a number of stored authorization requests associated with the user account data and the bank identification number submitted over a time period and determine that the authorization request is malicious in response to the number being greater than or equal to a threshold.

In other features, the authorization request comprises user account data. The second electronic processor is configured to parse stored authorization requests in the data store to determine a number of unique primary account numbers present in stored authorization requests associated with the user account data submitted over a time period and determine that the authorization request is malicious in response to the number being greater than or equal to a threshold. In other features, the authorization request comprises user account data and a primary account number. The second electronic processor is configured to parse stored authorization requests in the data store to determine a number of stored authorization requests associated with user account data and the primary account number submitted over a time period and determine that the authorization request is malicious in response to the number being greater than or equal to a threshold.

In other features, the authorization request comprises an Internet Protocol (IP) address and a primary account number. The second electronic processor is configured to parse stored authorization requests in the data store to determine a number of stored authorization requests associated with the IP address and the primary account number submitted over a time period. In other features, the authorization request comprises a bank identification number and a transaction amount. The second electronic processor is configured to parse stored authorization requests in the data store to determine a number of stored authorization requests associated with the bank identification number and the transaction amount submitted over a time period and determine that the authorization request is malicious in response to the number being greater than or equal to a threshold.

In other features, the authorization request comprises a primary account number. The second electronic processor is configured to parse stored authorization requests in the data store to determine a number of user accounts present in the stored authorization requests associated with the primary account number and determine that the authorization request is malicious in response to the number being greater than or equal to a threshold. In other features, the authorization request comprises an IP address. The second electronic processor is configured to parse stored authorization requests in the data store to determine a number of unique primary account numbers present in stored authorization requests associated with the IP address submitted over a period of time and determine that the authorization request is malicious in response to the number being greater than or equal to a threshold.

A method includes receiving, with an electronic processor of an intermediate client platform, an authorization request via a communications interface of the intermediate client platform, parsing, with the electronic processor, the authorization request to determine whether the authorization request is malicious, storing the authorization request in a data store of the intermediate client platform in response to determining that the authorization request is malicious, transmitting an authorization request denial via the communications interface in response to determining that the authorization request is malicious, and transmitting an incident payload including details of authorization request via the communications interface in response to determining that the authorization request is malicious. The authorization request is generated by an originating client platform. The communications interface is configured to transmit the incident payload to a bridge platform.

In other features, the electronic processor is configured to determine that the authorization request is malicious based on a velocity of stored authorization requests having a common merchant identifier and a common bank identification number. In other features, the electronic processor is configured to determine that the authorization request is malicious based on a velocity of unique bank identification numbers present in stored authorization requests having a common merchant identifier. In other features, the electronic processor is configured to determine that the authorization request is malicious based on a velocity of unique primary account numbers present in stored authorization requests having a common merchant identifier. In other features, the electronic processor is configured to determine that the authorization request is malicious based on a velocity of stored authorization requests having a common merchant identifier and a common primary account number.

Other examples, embodiments, features, and aspects will become apparent by consideration of the detailed description and accompanying drawings.

### BRIEF DESCRIPTION OF THE DRAWINGS

FIG. 1 is a functional block diagram of a networked computer system, according to some examples.

FIG. 2 is a message sequence chart showing interactions between components of a system as the system processes a non-malicious authorization request, according to some examples.

FIG. 3 is a schematic illustration of an authorization request generated by a transactions application, according to some examples.

FIG. 4 is a message sequence chart showing interactions between components of a system as the system processes a malicious authorization request, according to some examples.

FIG. 5 is a flowchart of a process for determining whether an authorization request is malicious based on a velocity of authorization requests having a common merchant identifier and a common bank identification number, according to some examples.

FIG. 6 is a flowchart of a process for determining whether an authorization request is malicious based on a velocity of unique bank identification numbers present in authorization requests having a common merchant identifier, according to some examples.

FIG. 7 is a flowchart of a process for determining whether an authorization request is malicious based on a velocity of unique primary account numbers present in authorization requests having a common merchant identifier, according to some examples.

FIG. 8 is a flowchart of a process for determining whether an authorization request is malicious based on a velocity of authorization requests having a common merchant identifier and a common primary account number, according to some examples.

FIG. 9 is a flowchart of a process for determining whether an authorization request is malicious based on a velocity of authorization requests having a common merchant identifier and a common transaction amount, according to some examples.

FIG. 10 is a flowchart of a process for determining whether an authorization request is malicious based on a velocity of authorization requests having a common primary account number and a common transaction amount, according to some examples.

FIG. 11 is a flowchart of a process for determining whether an authorization request is malicious based on a velocity of declined authorization requests associated with a merchant identifier, according to some examples.

FIG. 12 is a flowchart of a process for determining whether an authorization request is malicious based on a velocity of authorization requests associated with a common bank identification number and a common user account, according to some examples.

FIG. 13 is a flowchart of a process for determining whether an authorization request is malicious based on a velocity of unique primary account numbers, according to some examples.

FIG. 14 is a flowchart of a process for determining whether an authorization request is malicious based on a velocity of authorization requests associated with a common user account and a common primary account number, according to some examples.

FIG. 15 is a flowchart of a process for determining whether an authorization request is malicious based on a velocity of authorization requests associated with a common IP address and a common primary account number, according to some examples.

FIG. 16 is a flowchart of a process for determining whether an authorization request is malicious based on a velocity of authorization requests associated with a common bank identification number and a common transaction amount, according to some examples.

FIG. 17 is a flowchart of a process for determining whether an authorization request is malicious based on a velocity of authorization requests from unique user accounts having a common primary account number, according to some examples.

FIG. 18 is a flowchart of a process for determining whether an authorization request is malicious based on a velocity of unique primary account numbers originating from a common IP address, according to some examples.

FIG. 19 is a flowchart of a process for determining whether an authorization request is malicious based on a comparison of data from the authorization request to a statistical dispersion of corresponding historical transactional data, according to some examples.

In the drawings, reference numbers may be reused to identify similar and/or identical elements.

### DETAILED DESCRIPTION

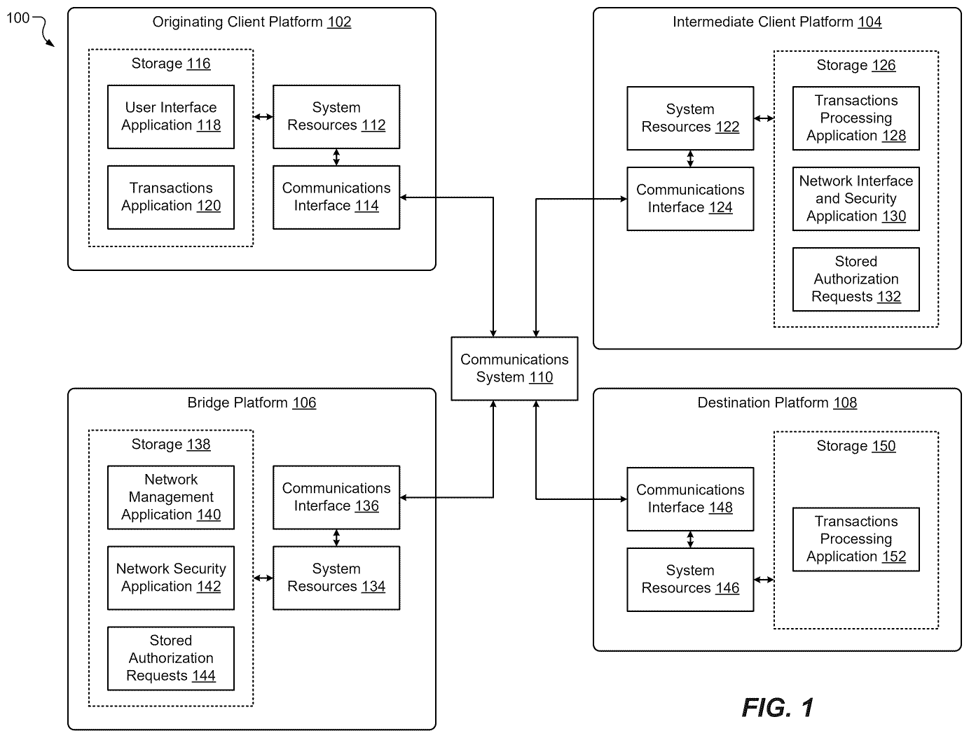

FIG. 1 is a functional block diagram of a networked computer system 100, according to some examples. As shown in FIG. 1, some implementations of the system 100 include a originating client platform 102, an intermediate client platform 104, a bridge platform 106, an destination client platform 108. The originating client platform 102, the intermediate client platform 104, the bridge platform 106, and the destination client platform 108 may communicate with one another via a communications system 110.

Examples of the communications system 110 include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 110 includes an optical network, a local area network, and/or a global communication network, such as the Internet.

While only a single originating client platform 102, issuer platform, 104, bridge platform 106, destination client platform 108, and communications system 110 are shown in FIG. 1, various implementations of the system 100 may include one or more of each platform and/or system. In various implementations, the originating client platform 102 includes system resources 112, a communications interface 114, and/or one or more data stores that include non-transitory computer-readable storage media, such as storage 116. The system resources 112 may include one or more electronic processors, one or more graphics processing units, volatile computer memory, non-volatile computer memory, and/or one or more system buses connecting components of the system resources 112, the communications interface 114, and/or the storage 116. In some examples, the storage 116 includes one or more software applications, such as a user interface application 118 and/or a transactions application 120. Functionality of the user interface application 118 and the transactions application 120 will be described further on in this specification with reference to the message sequence charts and/or flowcharts.

In some implementations, the intermediate client platform 104 includes system resources 122, a communications interface 124, and/or one or more data stores that include non-transitory computer-readable storage media, such as storage 126. The system resources 122 may include one or more electronic processors, one or more graphics processing units, volatile computer memory, non-volatile computer memory, and/or one or more system buses connecting components of the system resources 122, the communications interface 124, and/or the storage 126. In some examples, the storage 126 includes one or more software applications (such as a transactions processing application 128 and/or a network interface and security application 130) and/or stored authorization requests 132. Functionality of the transactions processing application 128 and the network interface and security application 130 will be described further on in this specification with reference to the message sequence charts and/or flowcharts.

In various implementations, the bridge platform 106 includes system resources 134, a communications interface 136, and/or one or more data stores that include non-transitory computer-readable storage media, such as storage 138. The system resources 134 may include one or more electronic processors, one or more graphics processing units, volatile computer memory, non-volatile computer memory, and/or one or more system buses connecting components of the system resources 134, the communications interface 136, and/or the storage 138. In some examples, the storage 138 includes one or more software applications (such as a network management application 140 and/or a security application 142) and/or stored authorization requests 144. Functionality of the network management application 140 and the network security application 142 will be described further on in this specification with reference to the message sequence charts and/or flowcharts.

In various implementations, the destination client platform 108 includes system resources 146, a communications interface 148, and/or one or more data stores that include non-transitory computer-readable storage media, such as storage 150. The system resources 146 may include one or more electronic processors, one or more graphics processing units, volatile computer memory, non-volatile computer memory, and/or one or more system buses connecting components of the system resources 146, the communications interface 148, and/or the storage 150. In some examples, the storage 150 includes one or more software applications, such as a transactions processing application 152. Functionality of the transactions processing application 152 will be described further on in this specification with reference to the message sequence charts and/or flowcharts.

Components of the originating client platform 102, the intermediate client platform 104, the bridge platform 106, and/or the destination client platform 108 may communicate with each other via the communications system 110. For example, components of the originating client platform 102 may communicate with the communications system 110 via the communications interface 114, components of the intermediate client platform 104 may communicate with the communications system 110 via the communications interface 124, components of the bridge platform 106 may communicate with the communications system 110 via the communications interface 136, and components of the destination client platform 108 may communicate with the communications system 110 via the communications interface 148.

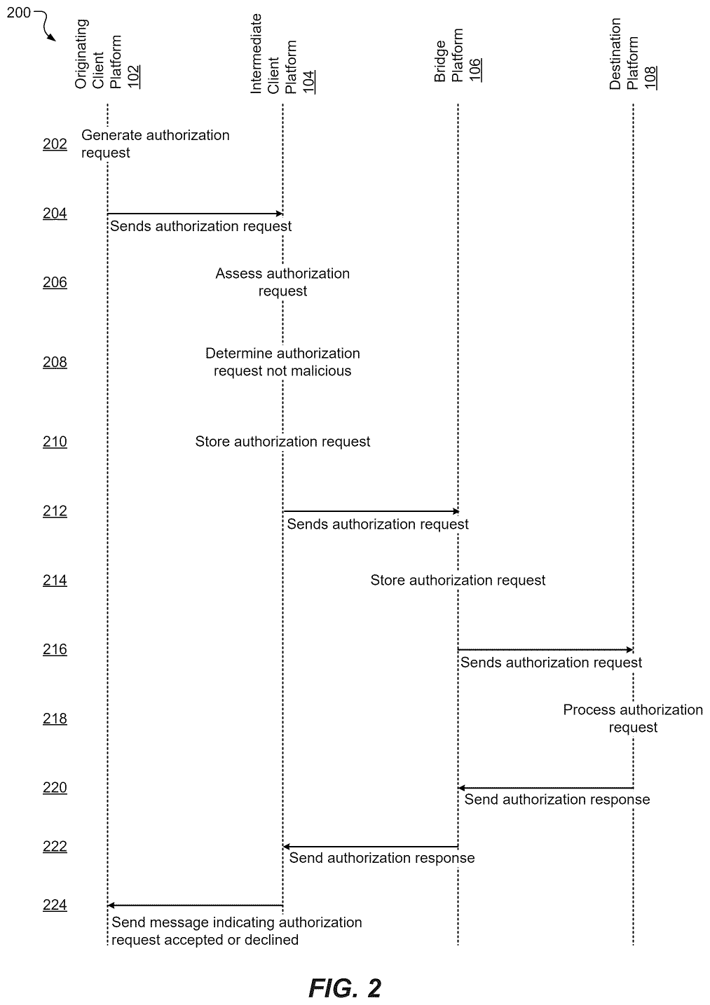

FIG. 2 is a message sequence chart 200 showing interactions between components of the system 100 as the system 100 processes a non-malicious authorization request, according to some examples. In the example message sequence chart 200, the transactions application 120 of the originating client platform 102 generates an authorization request (at operation 202). For example, the user interface application 118 of the originating client platform 102 may generate a graphical user interface for a user to input credit card information (such as a primary account number, a card expiration date, and/or a card verification value), billing information (such as a billing address), user account data (such as login information for a user account on the originating client platform 102), and/or a transaction amount. The transactions application 120 may add the information input into the graphical user interface to the authorization request. In various implementations, the transactions application 120 may determine a type of authorization the user is requesting (for example, whether the user is requesting a purchase transaction or a refund transaction), log a date and time of the user's request, and/or log an Internet Protocol (IP) address of the user. The transactions application 120 may generate the authorization request based on the information input into the graphical user interface, the logged information, and/or additional information generated by the transactions application 120.

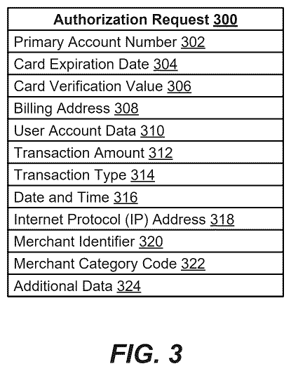

FIG. 3 is a schematic illustration of and authorization request 300 generated by the transactions application 120, according to some examples. For example, as shown in FIG. 3, the authorization request 300 may include a primary account number 302, a card expiration date 304, a card verification value 306, a billing address 308, user account data 310, a transaction amount 312, a transaction type 314, a date and time 316, an IP address 318, a merchant identifier 320, a merchant category code 322, and/or additional data 324.

In various implementations, the primary account number 302 includes a sequence of digits uniquely identifying a cardholder account, for example, formatted according to the ISO/IEC 7812 standard. In some examples, the primary account number 302 includes a combination of components, such as a bank identification number (BIN), an individual account identifier, and/or a check digit. For instance, the first 6-8 digits of the primary account number 302 may represent the BIN, which identifies the issuing institution. The subsequent digits of the primary account number 302 may represent an account number that uniquely identifies the cardholder within the issuing institution's system. The final digit may be a check digit computed to validate the integrity of the primary account number 302 (for example, computed according to the Luhn algorithm, the Verhoeff algorithm, the Damm algorithm, the ISO/IEC 7064 algorithm, or any other suitable algorithm).

In various implementations, the primary account number 302 includes a payment token. Structurally, a tokenized primary account number 302 may include a surrogate identifier that preserves the format of a numerical account number (for example, as previously described) while decoupling the identifier from the actual underlying account. For example, the token may retain a BIN-like prefix assigned from a range designed for tokenized values and may include randomized or otherwise non-sensitive digits in place of the actual account identifier. A tokenized primary account number 302 may be issued and managed by a token service provider, which maps the token to an actual numerical account number via a secure token vault.

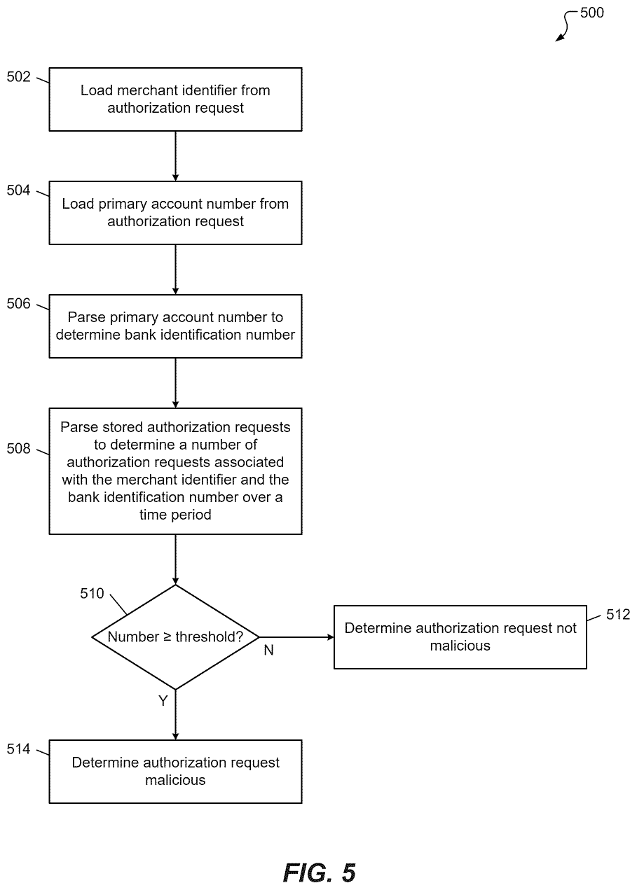

Returning to FIG. 2, in the example message sequence chart 200, the transactions application 120 may send the authorization request 300 to the transactions processing application 128 of the intermediate client platform 104 via the communications interface 114, the communications system 110, and the communications interface 124 (at operation 204). In the example message sequence chart 200, the network interface and security application 130 of the intermediate client platform 104 assesses the authorization request 300 to determine whether the authorization request 300 is malicious or not malicious (at operation 206). Additional details associated with determining whether the authorization request 300 is malicious or not malicious will be described further on in this specification with reference to FIGS. 5-19. In the example message sequence chart 200, the network interface and security application 130 determines that the authorization request 300 is not malicious (at operation 208). In the example message sequence chart 200, the network interface and security application 130 stores the authorization request 300 in the stored authorization requests 132 of storage 126 (at operation 210).

In the example message sequence chart 200, the transactions processing application 128 sends the authorization request 300 to the network management application 140 of the bridge platform 106 via the communications interface 124, the communications system 110, and the communications interface 136 (at operation 212). In the example message sequence chart 200, the network security application 142 of the bridge platform 106 stores the authorization request 300 in the stored authorization requests 144 (at operation 214). In the example message sequence chart 200, the network management application 140 sends the authorization request 300 to the transactions processing application 152 of the destination client platform 108 via the communications interface 136, the communications system 110, and the communications interface 148 (at operation 216). In the example message sequence chart 200, the transactions processing application 152 processes the authorization request 300 and generates an authorization response authorizing or declining the authorization request 300 (at operation 218). In the example message sequence chart 200, the transactions processing application 152 sends the authorization response to the network management application 140 via the communications interface 148, the communications system 110, and the communications interface 136 (at operation 220). In the example message sequence chart 200, the network management application 140 sends the authorization response to the transactions processing application 128 via the communications interface 136, the communications system 110, and the communications interface 124 (at operation 222). In the example message sequence chart 200, the transactions processing application 128 sends a message indicating whether the authorization request 300 was accepted or declined to the transactions application 120 via the communications interface 124, the communications system 110, and the communications interface 114 (at operation 224).

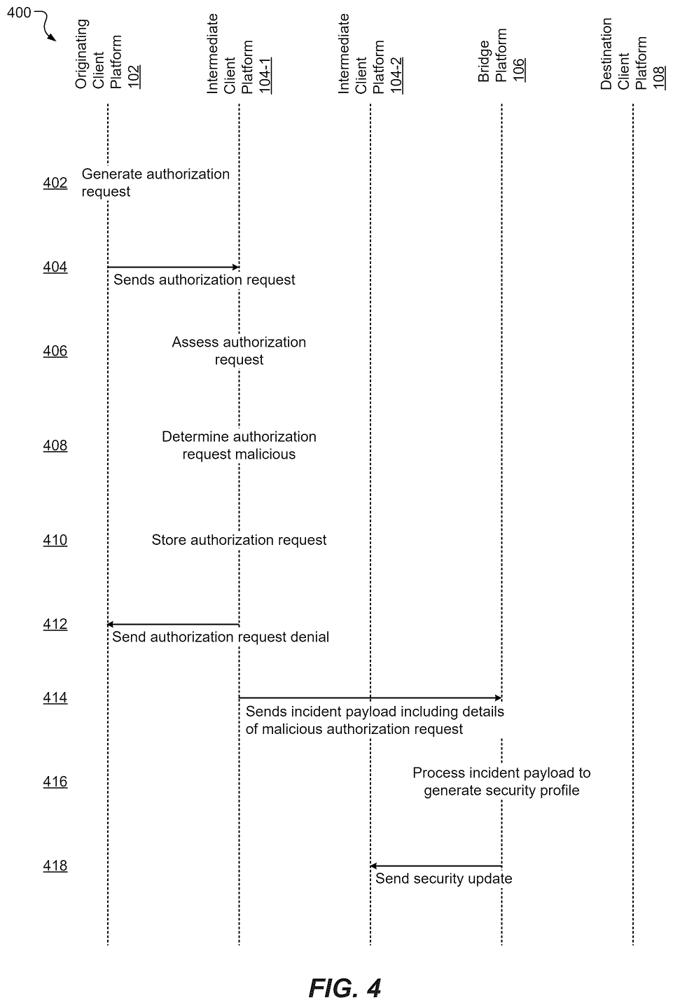

FIG. 4 is a message sequence chart 400 showing interactions between components of the system 100 as the system 100 processes a malicious authorization request, according to some examples. In the example message sequence chart 400, the transactions application 120 of the originating client platform 102 generates an authorization request (such as authorization request 300) (at operation 402). For example, the transactions application 120 generates the authorization request 300 as previously discussed with reference to FIGS. 2 and 3. In the example message sequence chart 400, the transactions application 120 sends the authorization request 300 to the transactions processing application 128 of a first intermediate client platform 104-1 via communications interface 114, communications system 110, and communications interface 124 (at operation 404). In the example message sequence chart 400, the network interface and security application 130 assesses the authorization request 300 to determine whether the authorization request 300 is malicious (at operation 406). Additional details associated with determining whether the authorization request 300 is malicious or not malicious will be described further on in this specification with reference to FIGS. 5-19. In various implementations, network interface and security application 130 may perform any combination of the processes 500-1900 of FIGS. 5-19 (for example, in parallel or sequentially).

In the example message sequence chart 400, the network interface and security application 130 determines that the authorization request 300 is malicious (at operation 408). For example, the network interface and security application 130 may determine that the authorization request 300 is malicious in response to any of the processes that will be described later on in this specification with reference to FIGS. 5-19 determining that the authorization request 300 is malicious. In the example message sequence chart 400, the network interface and security application 130 stores the authorization request in the stored authorization requests 132 of storage 126 (at operation 410).

In the example message sequence chart 400, the transactions processing application 128 sends an authorization request denial to the transactions application 120 of the originating client platform 102 via the communications interface 124, the communications system 110, and the communications interface 114 (at operation 412). In the example message sequence chart 400, the network interface and security application 130 of the intermediate client platform 104 sends an incident payload including details of the malicious authorization request 300 to the network security application 142 of the bridge platform 106 via the communications interface 124, the communications system 110, and the communications interface 136 (at operation 414). In the example message sequence chart 400, the network security application 142 processes the incident payload to generate a security profile (at operation 416). The security profile may include characteristics of the malicious authorization request 300. In various implementations, the security profile may include the authorization request 300 and a label identifying the authorization request 300 as being malicious. In the example message sequence chart 400, the network security application 142 sends the security profile to other issuer platforms in the system 100 (such as intermediate client platform 104-2) (at operation 418).

FIG. 5 is a flowchart of a process 500 for determining whether an authorization request is malicious based on a velocity of authorization requests having a common merchant identifier and a common bank identification number, according to some examples. In the example process 500, the network interface and security application 130 loads the merchant identifier 320 from the authorization request 300 (at block 502). In the example process 500, the network interface and security application 130 loads the primary account number 302 from the authorization request 300 (at block 504). In the example process 500, the network interface and security application 130 parses the primary account number 302 to determine a bank identification number (at block 506). In various implementations, the bank identification number may be an initial series of numbers of the primary account number 302 and indicate which bank or institution issued the credit card. In some examples, the bank identification number may be the first four, six, or eight digits of the primary account number 302.

In the example process 500, the network interface and security application 130 parses the stored authorization requests 132 and/or the stored authorization requests 144 to determine a number of authorization requests associated with the merchant identifier 320 and the bank identification number that were submitted over a time period (at operation 508). In some implementations, the time period may be the past hour, six hours, or 24 hours. In the example process 500, the network interface and security application 130 determines whether the number of authorization requests is greater than or equal to a threshold (at decision block 510). In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of authorization requests associated with the merchant identifier 320 and the bank identification number submitted over the time period present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number of authorization requests is not greater than or equal to the threshold (“NO” at decision block 510), the network interface and security application 130 determines that the authorization request 300 is not malicious (at block 512). In response to determining that the number of authorization requests is greater than or equal to the threshold (“YES” at decision block 510), the network interface and security application 130 determines that the authorization request 300 is malicious (at block 514).

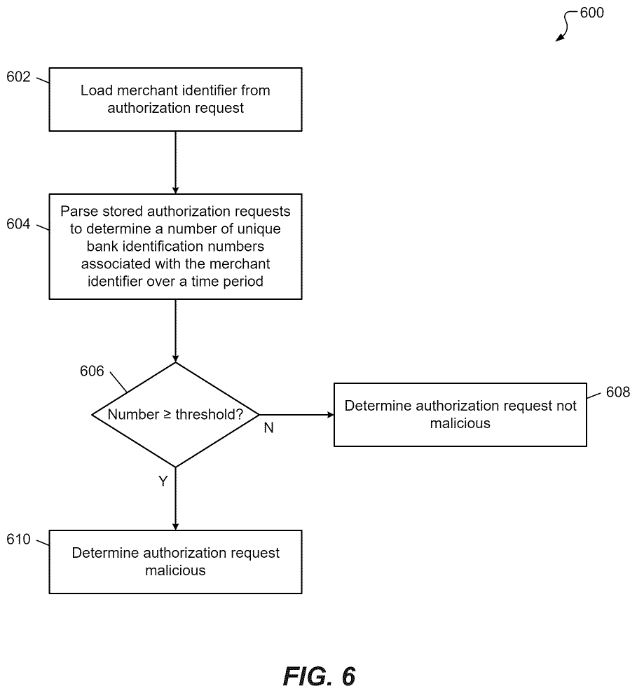

FIG. 6 is a flowchart of a process 600 for determining whether an authorization request is malicious based on a velocity of unique bank identification numbers present in authorization requests having a common a merchant identifier, according to some examples. In the example process 600, the network interface and security application 130 loads the merchant identifier 320 from the authorization request 300 (at block 602). In the example process 600, the network interface and security application 130 parses the stored authorization requests 132 and/or the stored authorization requests 144 to determine a number of unique bank identification numbers present in authorization requests associated with the merchant identifier 320 submitted over a time period (at block 604). In some examples, the time period is the past hour, six hours, or 24 hours.

In the example process 600, the network interface and security application 130 determines whether the number is greater than or equal to a threshold (at decision block 606). In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of unique bank identification numbers present in authorization requests associated with the merchant identifier 320 submitted over the time period present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number is not greater than or equal to the threshold (“NO” at decision block 606), the network interface and security application 130 determines that the authorization request 300 is not malicious (at block 608). In response to determining that the number is greater than or equal to the threshold (“YES” at decision block 606), the network interface and security application 130 determines that the authorization request 300 is malicious (at block 610).

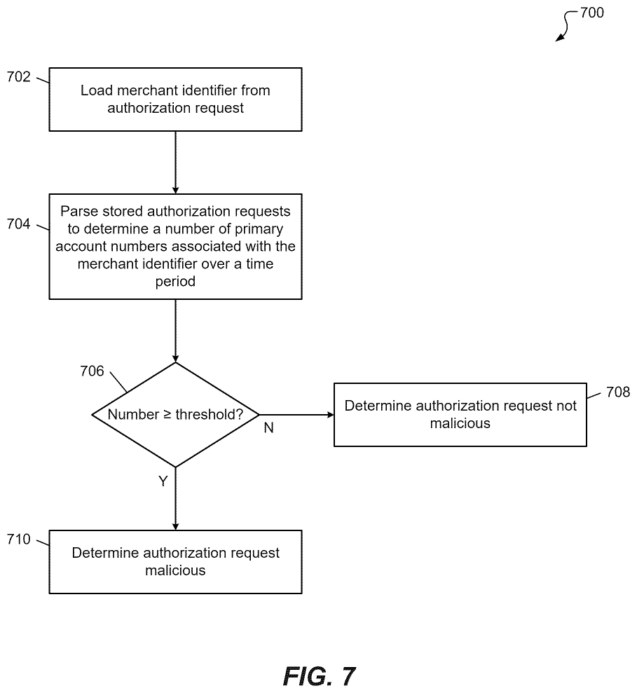

FIG. 7 is a flowchart of a process 700 for determining whether an authorization request is malicious based on a velocity of unique primary account numbers present in authorization requests having a common merchant identifier, according to some examples. In the example process 700, the network interface and security application 130 loads the merchant identifier 320 from the authorization request 300 (at block 702). In the example process 700, the network interface and security application 130 parses the stored authorization requests 132 and/or the stored authorization requests 144 to determine a number of distinct primary account numbers present in authorization requests having the same merchant identifier 320 as the authorization request 300 generated over a time period (at block 704). In various implementations, the time period is about an hour, six hours, or 24 hours.

In the example process 700, the network interface and security application 130 determines whether the number is greater than or equal to a threshold (at decision block 706). In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of distinct primary account numbers present in authorization requests having the same merchant identifier 320 as the authorization request 300 generated over the time period present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number is not greater than or equal to the threshold (“NO” at decision block 706), the network interface and security application 130 determines that the authorization request 300 is not malicious (at block 708). In response to determining that the number is greater than or equal to the threshold (“YES” at decision block 706), the network interface and security application 130 determines that the authorization request 300 is malicious (at block 710).

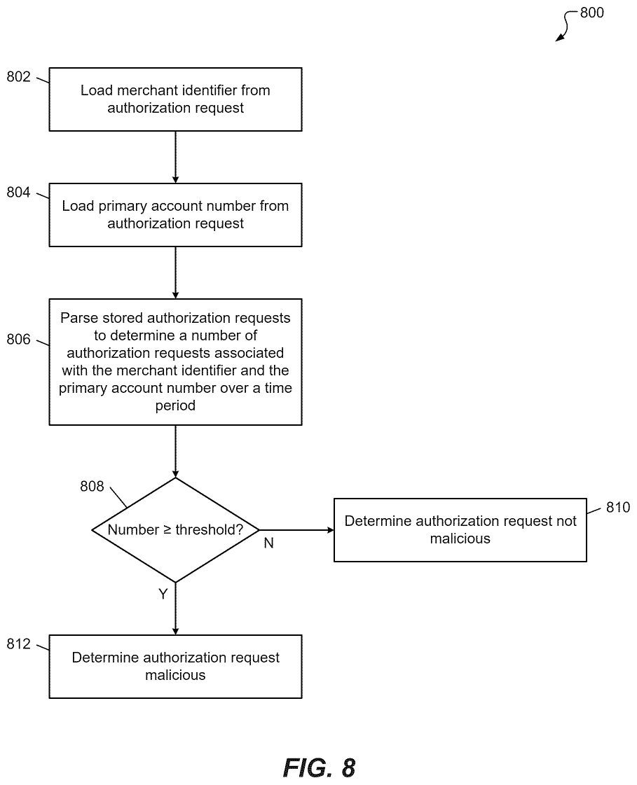

FIG. 8 is a flowchart of a process 800 for determining whether an authorization request is malicious based on a velocity of authorization requests having a common merchant identifier and a common primary account number, according to some examples. In the example process 800, the network interface and security application 130 loads the merchant identifier 320 from the authorization request 300 (at block 802). In the example process 800, the network interface and security application 130 loads the primary account number 302 from the authorization request 300 (at block 804). In the example process 800, the network interface and security application 130 parses the stored authorization requests 132 and/or the stored authorization requests 144 to determine a number of authorization requests having the merchant identifier 320 and the primary account number 302 that were submitted over a time period (at block 806). In various implementations, the time period is the past hour, six hours, or 24 hours.

In the example process 800, the network interface and security application 130 determines whether the number is greater than or equal to a threshold (at block 808). In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of authorization requests having the merchant identifier 320 and the primary account number 302 that were submitted over the time period present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number is not greater than or equal to the threshold (“NO” at decision block 808), the network interface and security application 130 determines that the authorization request 300 is not malicious (at block 810). In response to determining that the number is greater than or equal to the threshold (“YES” at decision block 808), the network interface and security application 130 determines that the authorization request 300 is malicious (at block 812).

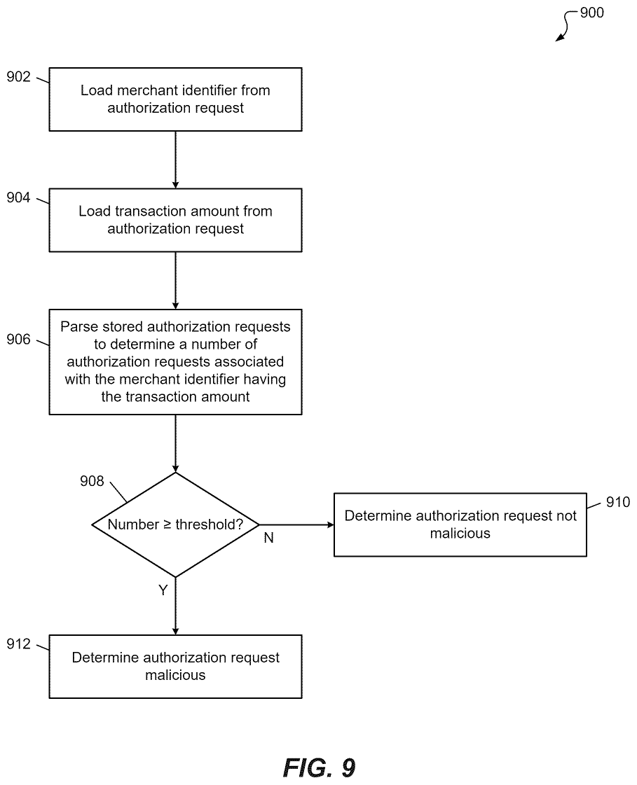

FIG. 9 is a flowchart of a process 900 for determining whether an authorization request is malicious based on a velocity of authorization requests having a common merchant identifier and a common transaction amount, according to some examples. In the example process 900, the network interface and security application 130 loads the merchant identifier 320 from the authorization request 300 (at block 902). In the example process 900, the network interface and security application 130 loads the transaction amount 312 from the authorization request 300 (at block 904). In the example process 900, the network interface and security application 130 parses the stored authorization requests 132 and/or the stored authorization requests 144 to determine a number of authorization requests that have the merchant identifier 320 and the transaction amount 312 (at block 906).

At decision block 908, the network interface and security application 130 determines whether the number is greater than or equal to the threshold. In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of authorization requests having the merchant identifier 320 and the transaction amount 312 present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number is not greater than or equal to the threshold (“NO” at decision block 908), the network interface and security application 130 determines that the authorization request 300 is not malicious (at block 910). In response to determining that the number is greater than or equal to the threshold (“YES” at decision block 908), the network interface and security application 130 determines that the authorization request is malicious (at block 912).

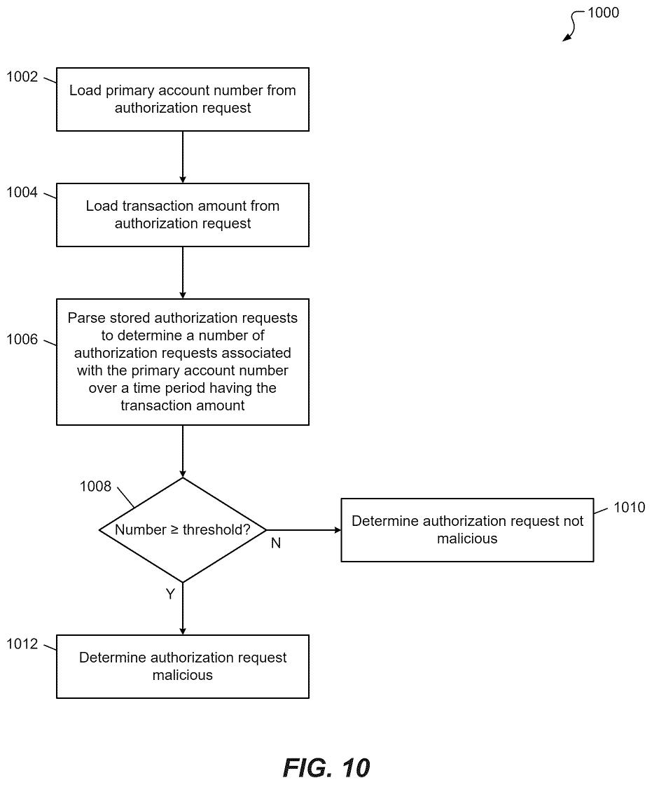

FIG. 10 is a flowchart of a process 1000 for determining whether an authorization request is malicious based on a velocity of authorization requests having a common primary account number and a common transaction amount, according to some examples. In the example process 1000, the network interface and security application 130 loads the primary account number 302 from the authorization request 300 (at block 1002). In the example process 1000, the network interface and security application 130 loads the transaction amount 312 from the authorization request 300 (at block 1004). In the example process 1000, the network interface and security application 130 parses the stored authorization requests 132 and/or the stored authorization requests 144 to determine a number of authorization requests having the primary account number 302 and the transaction amount 312 (at block 1006).

In the example process 1000, the network interface and security application 130 determines whether the number is greater than or equal to a threshold (at decision block 1008). In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of authorization requests having the primary account number 302 and the transaction amount 312 present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number is not greater than or equal to the threshold (“NO” at decision block 1008), the network interface and security application 130 determines that the authorization request 300 is not malicious (at block 1010). In response to determining that the number is greater than or equal to the threshold (“YES” at decision block 1008), the network interface and security application 130 determines that the authorization request 300 is malicious (at block 1012).

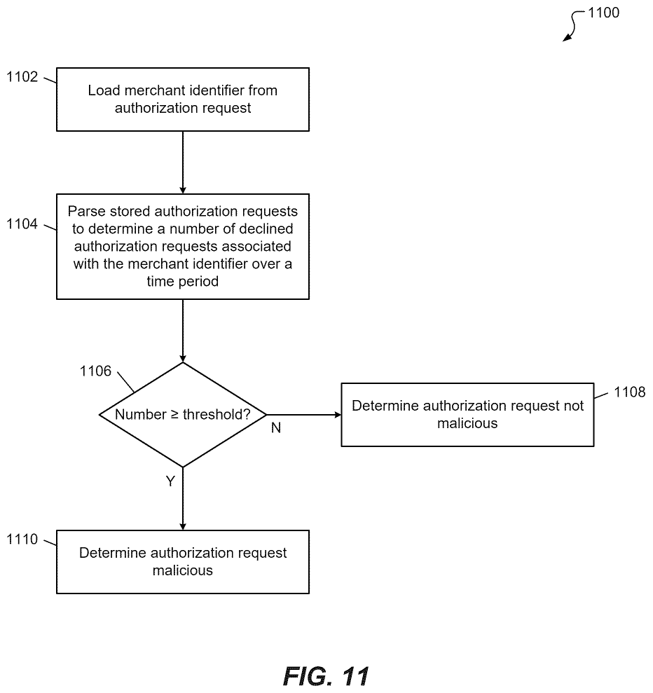

FIG. 11 is a flowchart of a process 1100 for determining whether an authorization request is malicious based on a velocity of declined authorization requests associated with a merchant identifier, according to some examples. In the example process 1100, the network interface and security application 130 loads the merchant identifier 320 from the authorization request 300 (at block 1102). In the example process 1100, the network interface and security application 130 parses the stored authorization requests 132 and/or the stored authorization requests 144 to determine a number of declined authorization requests associated with the merchant identifier 320 submitted over a time period (at block 1104). In various implementations, the time period is the past five minutes. In some examples, the time period is the past sixty minutes.

In the example process 1100, the network interface and security application 130 determines whether the number is greater than or equal to a threshold (at decision block 1106). In various implementations, the threshold may be dynamically calculated based on historical data in stored authorization requests 132 and/or stored authorization requests 144. For example, the network security interface and security application 130 may determine divide the historical data into a number of intervals (for example, the one hour, six hour, or 24 hour intervals). The network security and interface application 130 may (i) calculate an average number of declined authorization requests associated with the merchant identifier 320 submitted over the time period present in each division, (ii) calculate a mean of the averages for all of the divisions, and (iii) calculate a standard deviation of the averages for all of the divisions. The network interface and security application 130 may set the threshold at a number corresponding to a standard deviation of x. In various implementations, x may be about 200.

In response to determining that the number is not greater than or equal to the threshold (“NO” at decision block 1106), the network interface and security application 130 determines that the authorization request is not malicious (at block 1108). In response to determining that the number is greater than or equal to the threshold (“YES” at decision block 1106), the network interface and security application 130 determines that the authorization request is malicious (at block 1110).

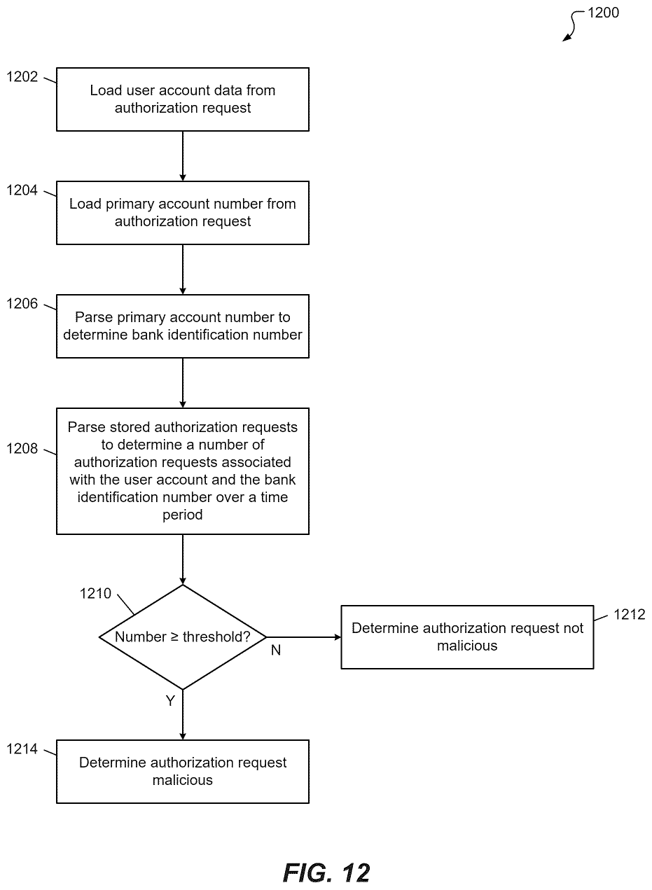

FIG. 12 is a flowchart of a process 1200 for determining whether an authorization request is malicious based on a velocity of authorization requests associated with a common bank identification number and a common user account, according to some examples. In the example process 1200, the network interface and security application 130 loads the user account data 310 from the authorization request 300 (at block 1202). In the example process 1200, the network interface and security application 130 loads the primary account number 302 from the authorization request 300 (at block 1204). In the example process 1200, the network interface and security application 130 parses the primary account number 302 to determine the bank identifier number (for example, as previously described) (at block 1206). In the example process 1200, the network interface and security application 130 parses the stored authorization requests 132 and/or the stored authorization requests 144 to determine a number of transactions associated with the user account and the bank identification number submitted over a time period (at operation 1208). In various implementations, the time period is the last sixty minutes.

In the example process 1200, the network interface and security application 130 determines whether the number is greater than or equal to a threshold (at decision block 1210). In various implementations, the threshold is 500. In response to determining that the number is not greater than or equal to the threshold (“NO” at decision block 1210), the network interface and security application 130 determines that the authorization request 300 is not malicious (at block 1212). In response to determining that the number is greater than or equal to the threshold (“YES” at decision block 1210), the network interface and security application 130 determines that the authorization request 300 is malicious (at block 1214).

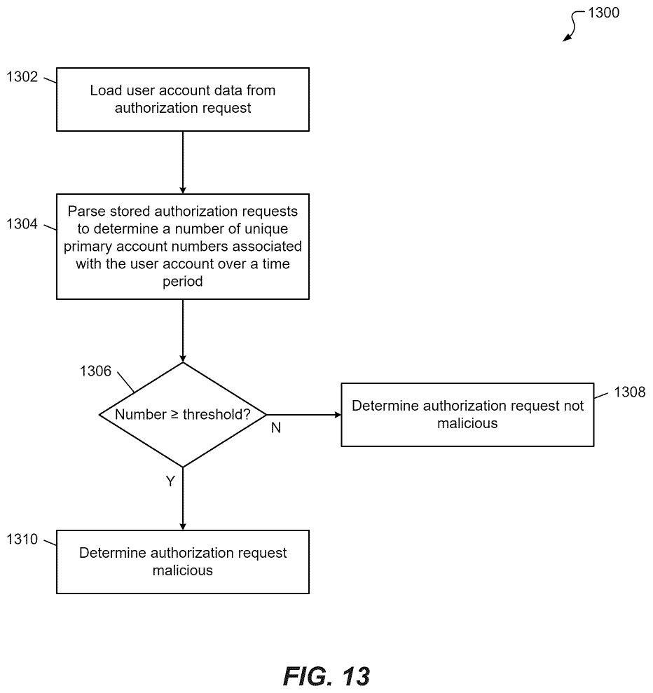

FIG. 13 is a flowchart of a process 1300 for determining whether an authorization request is malicious based on a velocity of unique primary account numbers, according to some examples. In the example process 1300, the network interface and security application 130 loads the user account data 310 from the authorization request 300 (at block 1302). In the example process 1300, the network interface and security application 130 parses stored authorization requests 132 and/or stored authorization requests 144 to determine a number of unique primary account numbers in authorization requests associated with the user account submitted over a time period (at block 1304). In various implementations, the time period is the past five minutes. In some examples, the time period is the past 60 minutes.

In the example process 1300, the network interface and security application 130 determines whether the number is greater than or equal to a threshold (at decision block 1306). In various implementations, the threshold is 300. In some implementations, the threshold is 600. In response to determining that the number is not greater than or equal to the threshold (“NO” at decision block 1306), the network interface and security application 130 determines that the authorization request is not malicious (at block 1308). In response to determining that the number is greater than or equal to the threshold (“YES” at decision block 1306), the network interface and security application 130 determines that the authorization request is malicious (at block 1310).

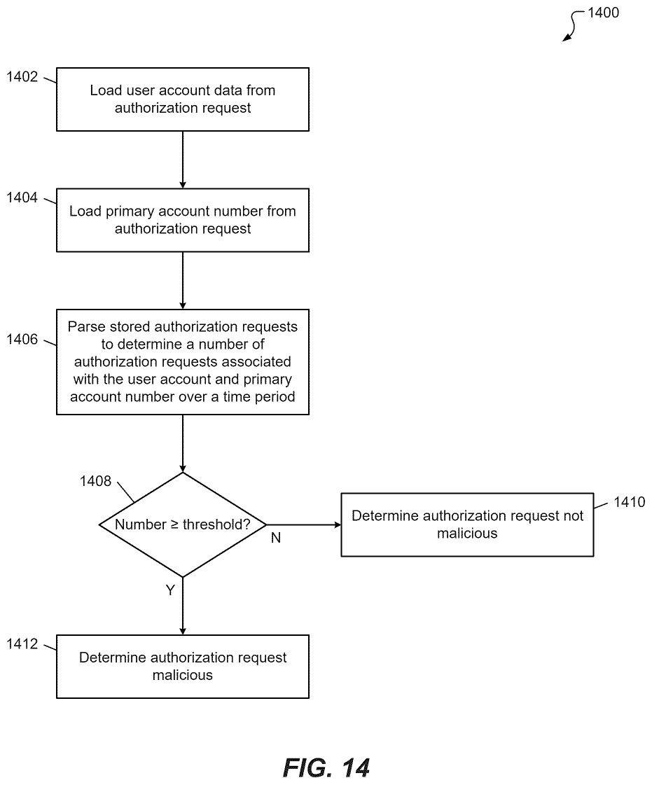

FIG. 14 is a flowchart of a process 1400 for determining whether an authorization request is malicious based on a velocity of authorization requests associated with a common user account and a common primary account number, according to some examples. In the example process 1400, the network interface and security application 130 loads user account data 310 from the authorization request 300 (at block 1402). In the example process 1400, the network interface and security application 130 loads the primary account number 302 from the authorization request 300 (at block 1404). In the example process 1400, the network interface and security application 130 parses the stored authorization requests 132 and/or stored authorization requests 144 to determine a number of authorization requests associated with the user account and primary account number 302 that were submitted over a time period (at block 1406). In various implementations, the time period is the past 24 hours. In some implementations, the time period is the past hour.

In the example process 1400, the network interface and security application 130 determines whether the number is greater than or equal to a threshold (at decision block 1408). In various implementations, the threshold is 200. In some embodiments, the threshold is 600. In response to determining that the number is not greater than or equal to the threshold (“NO” at decision block 1408), the network interface and security application 130 determines that the authorization request 300 is not malicious (at block 1410). In response to determining that the number is greater than or equal to the threshold (“YES” at decision block 1408), the network interface and security application 130 determines that the authorization request 300 is malicious (at block 1412).

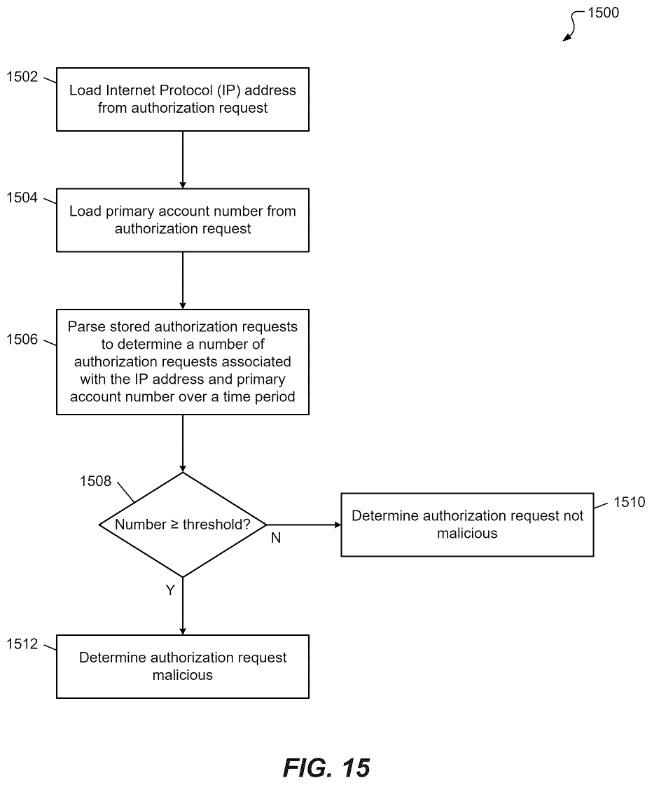

FIG. 15 is a flowchart of a process 1500 for determining whether an authorization request is malicious based on a velocity of authorization requests associated with a common IP address and a common primary account number, according to some examples. In the example process 1500, the network interface and security application 130 loads the IP address 318 from the authorization request 300 (at block 1502). In the example process 1500, the network interface and security application 130 loads the primary account number 302 from the authorization request 300 (at block 1504). In the example process 1500, the network interface and security application 130 parses the stored authorization requests 132 and/or the stored authorization requests 144 to determine a number of authorization requests associated with the IP address 318 and the primary account number 302 received over a time period (at block 1506). In various implementations, the threshold is the past five minutes.

In the example process 1500, the network interface and security application 130 determines whether the number is greater than or equal to a threshold (at decision block 1508). In some examples, the threshold is 300. In response to determining that the number is not greater than or equal to the threshold (“NO” at decision block 1508), the network interface and security application 130 determines that the authorization request 300 is not malicious (at block 1510). In response to determining that the number is greater than or equal to the threshold (“YES” at decision block 1508), the network interface and security application 130 determines that the authorization request 300 is malicious (at block 1512).

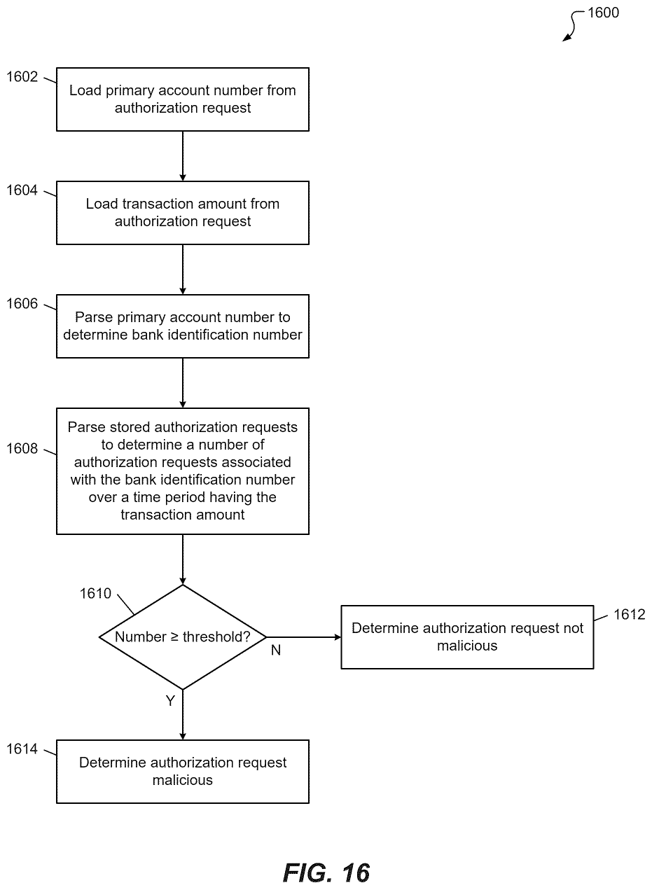

FIG. 16 is a flowchart of a process 1600 for determining whether an authorization request is malicious based on a velocity of authorization requests associated with a common bank identification number and a common transaction amount, according to some examples. In the example process 1600, the network interface and security application 130 loads the primary account number 302 from the authorization request 300 (at block 1602). In the example process 1600, the network interface and security application 130 loads the transaction amount 312 from the authorization request 300 (at block 1604). In the example process 1600, the network interface and security application 130 parses the primary account number 302 to determine the bank identification number (for example, as previously described) (at block 1606). In the example process 1600, the network interface and security application 130 parses the stored authorization requests 132 and/or the stored authorization requests 144 to determine a number of authorization requests submitted over a time period associated with the bank identification number and the transaction amount 312 (at block 1608). In some implementations, the time period is the past 24 hours.

In the example process 1600, the network interface and security application 130 determines whether the number is greater than or equal to a threshold (at decision block 1610). In various implementations, the threshold is 100. In response to determining that the number is not greater than or equal to the threshold (“NO” at decision block 1610), the network interface and security application 130 determines that the authorization request 300 is not malicious (at block 1612). In response to determining that the number is greater than or equal to the threshold (“YES” at decision block 1610), the network interface and security application 130 determines that the authorization request 300 is malicious (at block 1614).

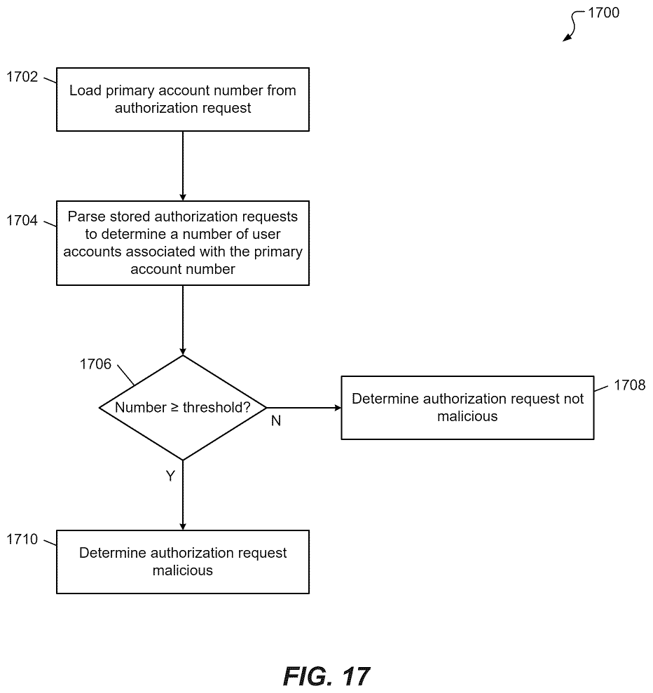

FIG. 17 is a flowchart of a process 1700 for determining whether an authorization request is malicious based on a velocity of authorization requests from unique user accounts having a common primary account number, according to some examples. In the example process 1700, the network interface and security application 130 loads the primary account number 302 from the authorization request 300 (at block 1702). In the example process 1700, the network interface and security application 130 parses the stored authorization requests 132 and/or the stored authorization requests 144 to determine a number of unique user accounts present in authorization requests submitted with the primary account number 302 (at block 1704).

In the example process 1700, the network interface and security application 130 determines whether the number is greater than or equal to a threshold (at decision block 1706). In various implementations, the threshold is five. In response to determining that the number is not greater than or equal to the threshold (“NO” at decision block 1706), the network interface and security application 130 determines that the authorization request 300 is not malicious (at block 1708). In response to determining that the number is greater than or equal to the threshold (“YES” at decision block 1706), the network interface and security application 130 determines that the authorization request 300 is malicious (at block 1710).

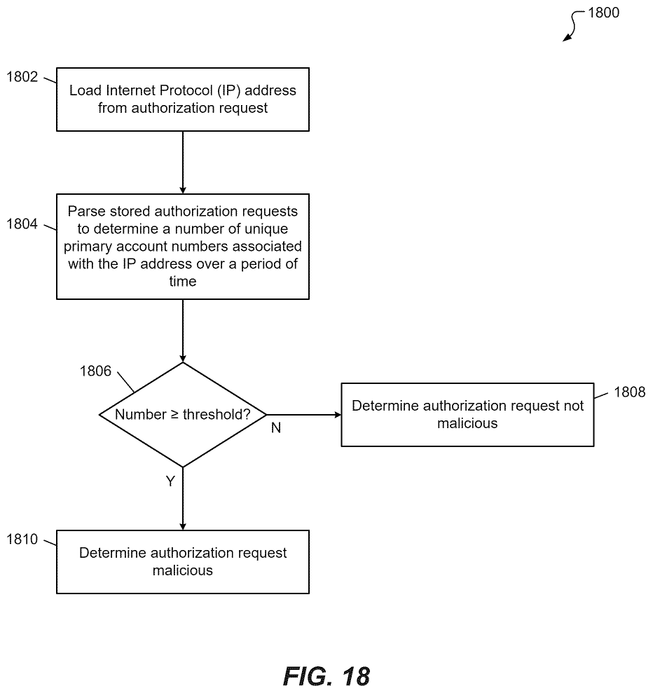

FIG. 18 is a flowchart of a process 1800 for determining whether an authorization request is malicious based on a velocity of unique primary account numbers originating from a common IP address, according to some examples. In the example process 1800, the network interface and security application 130 loads the IP address 318 from the authorization request 300 (at block 1802). In the example process 1800, the network interface and security application 130 parses the stored authorization requests 132 and the stored authorization requests 144 to determine a number of unique primary account numbers present in authorization requests submitted from the IP address 318 over a period of time (at block 1804). In various implementations, the period of time is the past five minutes. In some implementations, the period of time is the past 60 minutes.

In the example process 1800, the network interface and security application 130 determines whether the number is greater than or equal to a threshold (at decision block 1806). In some examples, the threshold is 300. In some implementations, the threshold is 500. In response to determining that the number is not greater than or equal to the threshold (“NO” at decision block 1806), the network interface and security application 130 determines that the authorization request 300 is not malicious (at block 1808). In response to determining that the number is greater than or equal to the threshold (“YES” at decision block 1806), the network interface and security application 130 determines that the authorization request 300 is malicious (at block 1810).

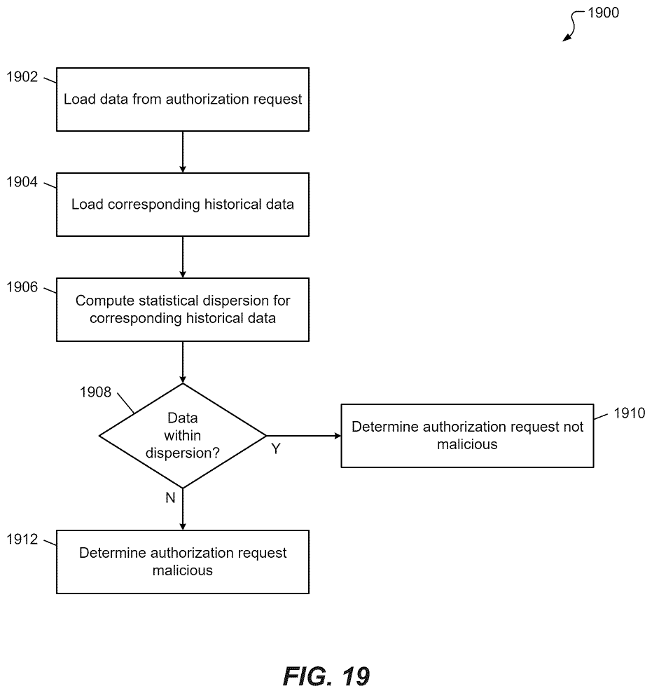

FIG. 19 is a flowchart of a process 1900 for determining whether an authorization request is malicious based on a comparison of data from the authorization request to a statistical dispersion of corresponding historical transactional data, according to some examples. Such an approach may facilitate the individualized detection of anomalous behavior by comparing the current request against historical norms associated for that specific account, rather than using system-wide or global thresholds.

In the example process 1900, the network interface and security application 130 loads data from the authorization request 300 (at block 1902). The data may include, for example, a transaction amount, a number of transactions submitted over a defined period, a time of day the transaction was submitted, a day of week, a merchant category code, a transaction location, or any other suitable transaction-related parameter. The loaded data may be associated with the primary account number 302, user account data 310, and/or other identifiers present in the authorization request 300.

In the example process 1900, the network interface and security application loads the corresponding historical data for the same type of transaction parameter(s) (at block 1904). The historical data may be retrieved from the stored authorization requests 132 and/or stored authorization requests 144 and may be filtered to include authorization requests associated with the primary account number 302, the user account data 310, etc. For example, when the parameter of interest is a transaction amount, the application may retrieve a history of past transaction amounts associated with the account over a defined historical period (e.g., 30 days, 60 days, 90 days, 365 days, etc.).

In the example process 1900, the network interface and security application 130 computes a statistical dispersion of the loaded historical data (at block 1906). In some implementations, the dispersion is calculated using a standard deviation, although other statistical measures may be used in other implementations, such as, for example, interquartile range, median absolute deviation, variance, etc. The dispersion may provide a dynamically computed and individualized baseline for evaluating whether the current transaction data deviates significantly from the account's historical patterns.

In the example process 1900, the network interface and security application 130 determines whether the authorization request 300 (e.g., loaded at block 1902) falls within the bounds of the computed dispersion (at decision block 1908). For example, the network interface and security application 130 may determine whether the current value lies within one, two, or three standard deviations from the historical mean. In some implementations, the bounds used for this determination may be configured based on system policies, risk models, or threat intelligence inputs (for example, the bounds may be adjusted higher or lower based on the current threat intelligence situation).

In response to determining that the data from the authorization request 300 falls within the dispersion (“YES” at decision block 1908), the network interface and security application 130 may determine that the authorization request 300 is not malicious (at block 1910). In response to determining that the data from the authorization request 300 falls outside of the dispersion (“NO” at decision block 1908), the network interface and security application 130 determines that the authorization request 300 is malicious (at block 1912).

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

The term computer-readable medium does not encompass transitory electrical or electromagnetic signals or electromagnetic signals propagating through a medium-such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices-such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A system comprising:
an originating client platform including a first electronic processor and a first communications interface;
a first intermediate client platform including a second electronic processor, a second communications interface, and a data store; and
a bridge platform including a third electronic processor and a third communications interface;
wherein the first electronic processor is configured to generate an authorization request and transmit the authorization request via the first communications interface;
wherein the second electronic processor is configured to:
receive the authorization request via the second communications interface,
determine whether the authorization request is malicious or not malicious, and
in response to determining that the authorization request is malicious:
store the authorization request in the data store,
transmit an authorization request denial via the second communications interface, and
transmit an incident payload including details of the authorization request via the second communications interface, and
wherein the third electronic processor is configured to:
receive the incident payload via the third communications interface,
generate a security profile based on the incident payload, and
transmit the security profile to a second intermediate client platform via the third communications interface.

2. The system of claim 1, wherein:
the authorization request includes a merchant identifier and a bank identification number; and
the second electronic processor is configured to:
parse stored authorization requests in the data store to determine a number of stored authorization requests that include the merchant identifier and the bank identification number submitted over a time period, and
determine that the authorization request is malicious in response to the number being greater than or equal to a threshold.

3. The system of claim 1, wherein:
the authorization request includes a merchant identifier; and
the second electronic processor is configured to:
parse stored authorization requests in the data store to determine a number of unique bank identification numbers present in stored authorization requests associated with the merchant identifier submitted over a time period, and
determine that the authorization request is malicious in response to the number being greater than or equal to a threshold.

4. The system of claim 1, wherein:
the authorization request comprises a merchant identifier; and
the second electronic processor is configured to:
parse stored authorization requests in the data store to determine a number of unique primary account numbers present in the stored authorization requests associated with the merchant identifier submitted over a time period, and
determine that the authorization request is malicious in response to the number being greater than or equal to a threshold.

5. The system of claim 1, wherein
the authorization request comprises a merchant identifier and a primary account number; and
the second electronic processor is configured to:
parse stored authorization requests in the data store to determine a number of stored authorization requests associated with the merchant identifier and the primary account number, and
determine that the authorization request is malicious in response to the number being greater than or equal to a threshold.

6. The system of claim 1, wherein:
the authorization request comprises a merchant identifier and a transaction amount; and
the second electronic processor is configured to:
parse stored authorization requests in the data store to determine a number of stored authorization requests associated with the merchant identifier and the transaction amount, and
determine that the authorization request is malicious in response to the number being greater than or equal to a threshold.

7. The system of claim 1, wherein:
the authorization request comprises a primary account number and a transaction amount; and
the second electronic processor is configured to:
parse stored authorization requests in the data store to determine a number of stored authorization requests associated with the primary account number and the transaction amount submitted over a time period, and
determine that the authorization request is malicious in response to the number being greater than or equal to a threshold.

8. The system of claim 1, wherein:
the authorization request comprises a merchant identifier; and
the second electronic processor is configured to:
parse stored authorization requests in the data store to determine a number of declined authorization requests associated with the merchant identifier submitted over a time period, and
determine that the authorization request is malicious in response to the number being greater than or equal to a threshold.

9. The system of claim 1, wherein:
the authorization request comprises user account data and a bank identification number; and
the second electronic processor is configured to:
parse stored authorization requests in the data store to determine a number of stored authorization requests associated with the user account data and the bank identification number submitted over a time period, and
determine that the authorization request is malicious in response to the number being greater than or equal to a threshold.

10. The system of claim 1, wherein:
the authorization request comprises user account data; and
the second electronic processor is configured to:
parse stored authorization requests in the data store to determine a number of unique primary account numbers present in stored authorization requests associated with the user account data submitted over a time period, and
determine that the authorization request is malicious in response to the number being greater than or equal to a threshold.

11. The system of claim 1, wherein:
the authorization request comprises user account data and a primary account number; and
the second electronic processor is configured to:
parse stored authorization requests in the data store to determine a number of stored authorization requests associated with user account data and the primary account number submitted over a time period, and
determine that the authorization request is malicious in response to the number being greater than or equal to a threshold.

12. The system of claim 1, wherein:
the authorization request comprises an Internet Protocol (IP) address and a primary account number; and
the second electronic processor is configured to:
parse stored authorization requests in the data store to determine a number of stored authorization requests associated with the IP address and the primary account number submitted over a time period.

13. The system of claim 1, wherein:
the authorization request comprises a bank identification number and a transaction amount; and
the second electronic processor is configured to:
parse stored authorization requests in the data store to determine a number of stored authorization requests associated with the bank identification number and the transaction amount submitted over a time period, and
determine that the authorization request is malicious in response to the number being greater than or equal to a threshold.

14. The system of claim 1, wherein:
the authorization request comprises a primary account number; and
the second electronic processor is configured to:
parse stored authorization requests in the data store to determine a number of user accounts present in the stored authorization requests associated with the primary account number, and
determine that the authorization request is malicious in response to the number being greater than or equal to a threshold.

15. The system of claim 1, wherein:
the authorization request comprises an IP address; and
the second electronic processor is configured to:
parse stored authorization requests in the data store to determine a number of unique primary account numbers present in stored authorization requests associated with the IP address submitted over a period of time, and
determine that the authorization request is malicious in response to the number being greater than or equal to a threshold.

16. A method comprising:
receiving, with an electronic processor of an intermediate client platform, an authorization request via a communications interface of the intermediate client platform, wherein the authorization request is generated by an originating client platform;
parsing, with the electronic processor, the authorization request to determine whether the authorization request is malicious;
storing the authorization request in a data store of the intermediate client platform in response to determining that the authorization request is malicious;
transmitting an authorization request denial via the communications interface in response to determining that the authorization request is malicious; and
transmitting an incident payload including details of authorization request via the communications interface in response to determining that the authorization request is malicious, wherein the communications interface is configured to transmit the incident payload to a bridge platform.

17. The method of claim 16, wherein the electronic processor is configured to determine that the authorization request is malicious based on a velocity of stored authorization requests having a common merchant identifier and a common bank identification number.

18. The method of claim 16, wherein the electronic processor is configured to determine that the authorization request is malicious based on a velocity of unique bank identification numbers present in stored authorization requests having a common merchant identifier.

19. The method of claim 16, wherein the electronic processor is configured to determine that the authorization request is malicious based on a velocity of unique primary account numbers present in stored authorization requests having a common merchant identifier.

20. The method of claim 16, wherein the electronic processor is configured to determine that the authorization request is malicious based on a velocity of stored authorization requests having a common merchant identifier and a common primary account number.
